(19) United States
(12) Patent Application Publication
(10) Pub. No.: US 2013/0153823 A1
(43) Pub. Date: Jun. 20, 2013

(54) RARE EARTH-ALUMINIUM/GALLATE BASED FLUORESCENT MATERIAL AND MANUFACTURING METHOD THEREOF

(71) Applicants: Mingjie Zhou, Shenzhen (CN); Jun Liu, Shenzhen (CN); Wenbo Ma, Shenzhen (CN)

(72) Inventors: Mingjie Zhou, Shenzhen (CN); Jun Liu, Shenzhen (CN); Wenbo Ma, Shenzhen (CN)

(21) Appl. No.: 13/643,165

(22) PCT Filed: Apr. 30, 2010
(86) PCT No.: PCT/CN2010/072379

§ 371 Date: Dec. 27, 2012

(51) Int. Cl. C09K 11/77

(52) U.S. Cl. CPC C09K 11/7721
USPC 252/301.4 R

(57) ABSTRACT

A rare earth-aluminium/gallate based fluorescent material and manufacturing method thereof are provided. Said rare earth-aluminium/gallate based fluorescent material comprises a core, and a shell which coats said core, wherein said core is a metal nanoparticle, and said shell is a fluorescent powder of chemical formula (Y₁₋ₓCeₓ)₃(Al_{1-y}Ga_{y})₅O₁₂, 0<x≦0.5, 0≦y≦1.0. Said rare earth-aluminium/gallate based fluorescent material has a uniform particle size distribution, a stable structure, a high luminous efficiency and a high luminous strength. The manufacturing method has the following properties: a simple technique, a low demand for equipments, no pollution, easily controllable reactions, material shapes and particle sizes, and being suitable for industrial manufacture.

### FIELD OF THE INVENTION

The invention relates to fluorescent material technology field. More particularly, the invention relates to a rare earth-aluminium/gallate based fluorescent material and manufacturing method thereof.

### BACKGROUND OF THE INVENTION

Researches show that luminous performances of fluorescent powder have a relationship with the morphology and particle size thereof. The spherical or spherical-like fluorescent powder having a uniformity of 3 to 5 μm is of high luminous intensity and easy to use. However, luminous performances of fluorescent powder also have a close relationship with the preparation method thereof. Herein, the preparation process of high-temperature solid-state method is simple and suitable for industrial production, but, due to the limitations of the method, the luminous center in the matrix disperses nonuniformly, affecting their luminous efficiency. Also, a ball milling process is required because the particle size of prepared fluorescent powder is quite large. Impurities can be easily introduced and lattice defects can be caused during the ball milling process. Physical and chemical changes caused by the ball milling often lead to reduce luminance of fluorescent powder, which is unfavorable for their application. Therefore, how to improve the luminance of the fluorescent powder by improving the preparation methods thereof has been an important part of the fluorescent materials research in the field of materials chemistry and materials physics.

### SUMMARY OF THE INVENTION

In view of this, a rare earth-aluminium/gallate based fluorescent material having the advantages of uniform particle size, structure stability, excellent luminous intensity and luminous efficiency is provided.

And, a manufacturing method of rare earth-aluminium/gallate based fluorescent material having a simple process, low demand on equipment and no pollution, being easily controllable for the reaction, material morphology and particle size, and suitable for industrial production is provided.

The technical solution to solve the technical problem of the present invention is:

A rare earth-aluminium/gallate based fluorescent material comprising a core and a shell which coats said core, wherein said core is metal nanoparticle, and said shell is fluorescent powder having chemical formula of (Y₁₋ₓCeₓ)₃(Al_{1-y}Ga_{y})₅O₁₂, wherein 0<x≦0.5, 0≦y≦1.0.

And, a manufacturing method of rare earth-aluminium/gallate based fluorescent material is provided, comprising:

dissolving corresponding metal compound of metal nanoparticle, and then mixing with assistant agent and reducing agent successively, to obtain metal nanoparticle collosol; adding the metal nanoparticle collosol into the surface treatment agent polyvinylpyrrolidone, mixing and stirring to obtain metal nanoparticle blended collosol;

according to the stoichiometric ratio of the corresponding elements in the chemical formula of (Y₁₋ₓCeₓ)₃(Al_{l-y}Ga_{y})₅O₁₂, mixing yttrium salt, cerium salt, aluminum salt, gallium salt, then adding into said metal nanoparticle blended collosol under the temperature in the range of 70 to 90° C., obtaining metal mixed solution, wherein <x≦0.5, 0≦y≦1.0;

adding citric acid monohydrate into metal mixed solution, then adjusting pH of mixed solution to 3 to 5 with weak base, keeping the temperature constant in a range of 70 to 90° C. for 3 to 6 hours, then drying to obtain precursor;

pre-burning said precursor, then calcinating in reducing atmosphere, cooling and then grinding, obtaining said rare earth-aluminium/gallate based fluorescent material.

In said rare earth-aluminium/gallate based fluorescent material and manufacturing method thereof, the rare earth-aluminium/gallate based fluorescent material is particulate fluorescent material having spherical or spherical-like structure, which comprises a core and shell, where the core is metal nanoparticle, and the shell is (Y₁₋ₓCeₓ)₃(Al_{1-y}Ga_{y})₅O₁₂. It makes the luminous intensity of the fluorescent material high by taking Ce as a luminous center, and the excitation band of said fluorescent material matches blue LED chips; the fluorescent material has a uniform particle size distribution, stable structure, excellent luminous efficiency; by coating metal nanoparticle, the luminous intensity of the fluorescent material is improved, and the position of the main emission peak is changed, which gives the fluorescent material a great value in use and adjustment of color temperature and spectrum; the rare earth-aluminium/gallate based fluorescent material is prepared by using wet chemical method, that not only lower the temperature in the synthesis reaction, but also improve the microstructure and macroscopic properties of the rare earth-aluminium/gallate based fluorescent material, the obtained rare earth-aluminium/gallate based fluorescent material have uniform particle size distribution, the luminescent performances of the material are improved effectively. Also, the particle size of the rare earth-aluminium/gallate based fluorescent material can be flexibly adjusted by controlling the metal nanoparticle diameter and the thickness of the fluorescent powder without the introduction of other impurities to obtain products of high quality. Meanwhile, the only requirement of the manufacturing method of the rare earth-aluminium/gallate based fluorescent material is to control temperature and add reactants in an appropriate proportion, the products can be obtained. Thus, the preparation process is simple, low equipment requirements, no pollution, easy to control, suitable for industrial production.

### BRIEF DESCRIPTION OF THE DRAWINGS

Further description of the present invention will be illustrated, which combined with embodiments in the drawings:

FIG. 1 is an emission spectrum of rare earth-aluminium/gallate based fluorescent material in Example 2 of the present invention with respect to (Y_{0.98}Ce_{0.02})₃Al₅O₁₂ at an excitation wavelength of 473 nm. Herein, curve 1 is the emission spectrum of the fluorescent material (Y_{0.98}Ce_{0.02})₃Al₅O₁₂@Ag; curve 2 is the emission spectrum of the fluorescent material (Y_{0.98}Ce_{0.02})₃Al₅O₁₂.

FIG. 2 is an excitation spectrum of rare earth-aluminium/gallate based fluorescent material in Example 2 of the present invention with respect to (Y_{0.98}Ce_{0.02})₃Al₅O₁₂. Herein, curve 1 is the excitation spectrum of the fluorescent material (Y_{0.98}Ce_{0.02})₃Al₅O₁₂@Ag at a monitoring wavelength of 542 nm; curve 2 is the excitation spectrum of the fluorescent material (Y_{0.98}Ce_{0.02})₃Al₅O₁₂ at a monitoring wavelength of 552 nm.

### DETAILED DESCRIPTION OF ILLUSTRATED EMBODIMENTS

Further description of the present invention will be illustrated, which combined with embodiments in the drawings, in order to make the purpose, the technical solution and the advantages clearer. While the present invention has been described with reference to particular embodiments, it will be understood that the embodiments are illustrative and that the invention scope is not so limited.

The present invention provides a rare earth-aluminium/gallate based fluorescent material comprising a core and a shell which coats said core, wherein said core is metal nanoparticle, and said shell is a fluorescent powder having chemical formula of (Y₁₋ₓCeₓ)₃(Al_{1-y}Ga_{y})₅O₁₂, wherein 0<x≦0.5, 0≦y≦1.0.

The chemical formula of said rare earth-aluminium/gallate based fluorescent material can be expressed as: (Y₁₋ₓCeₓ)₃(Al_{1-y}Ga_{y})₅O₁₂@zM, wherein, @ stands for taking M as core, taking (Y₁₋ₓCeₓ)₃(Al_{1-y}Ga_{y})₅O₁₂ as shell, M is coated in (Y₁₋ₓCeₓ)₃(Al_{1-y}Ga_{y})₅O₁₂. Where, 0<x≦0.5, preferably, 0.02≦x≦0.25; 0≦y≦0.7, preferably, 0.2≦y≦0.8 or/and 1×10⁻⁴≦y≦1×10⁻³; z is the molar ratio of M to (Y₁₋ₓCeₓ)₃(Al_{1-y}Ga_{y})₅O₁₂, 0<z≦1×10⁻²; M is metal nanoparticle, preferably at least one of Ag, Au, Pt, Pd nanoparticle.

The shell coats said core in layered form, said rare earth-aluminium/gallate based fluorescent material has spherical or spherical-like particulate structure.

Said rare earth-aluminium/gallate based fluorescent material is particulate fluorescent material having spherical or spherical-like structure, which comprises a core and shell, where the core is metal nanoparticle, and the shell is (Y₁₋ₓCeₓ)₃(Al_{1-y}Ga_{y})₅O₁₂. It takes Ce as a luminous center. The excitation band of said fluorescent material is in a range of 400 to 520 nm which matches blue LED chips; the emission band is in a range of 475 to 675, the high luminous intensity is high, even higher than that of the commercial powders YAG:Ce.

By coating metal nanoparticle, the luminous intensity of said rare earth-aluminium/gallate based fluorescent material is improved, and the position of the main emission peak is changed, which gives the fluorescent material a great value in use. At the same time, the fluorescent material has a uniform particle size distribution, a stable structure. Enhancing the fluorescence by plasmon resonance generated on metal surface, the luminous efficiency and luminous intensity of the fluorescent powder is greatly improved.

Moreover, the present invention provides a manufacturing method of said rare earth-aluminium/gallate based fluorescent material, comprising:

dissolving corresponding metal compound of metal nanoparticle, and then mixing with assistant agent and reducing agent successively, to obtain metal nanoparticle collosol;

adding the metal nanoparticle collosol into the surface treatment agent polyvinylpyrrolidone, mixing and stirring to obtain metal nanoparticle blended collosol;

according to the stoichiometric ratio of the corresponding elements in the chemical formula of (Y₁₋ₓCeₓ)₃(Al_{1-y}Ga_{y})₅O₁₂, mixing yttrium salt, cerium salt, aluminum salt, gallium salt, then adding into said metal nanoparticle blended collosol under the temperature in the range of 70 to 90° C., obtaining metal mixed solution, wherein <x≦0.5, 0≦y≦1.0;

adding citric acid monohydrate into metal mixed solution, then adjusting pH of mixed solution to 3 to 5 with weak base, keeping the temperature constant in a range of 70 to 90° C. for 3 to 6 hours, then drying to obtain precursor;

pre-burning said precursor, then calcinating in reducing atmosphere, cooling and then grinding, obtaining said rare earth-aluminium/gallate based fluorescent material.

A preferred method of making said metal nanoparticle collosol is:

1) weighing corresponding metal compound of metal nanoparticle and dissolving in solvent, to prepare metal salt solution, said metal compound is preferably at least one of silver nitrate, chloroauric acid, chloroplatinic acid, palladium chloride; said solvent is preferably but not limited to water and/or ethanol;

2) under the condition of magnetic stirring, dissolving one or more assistant agent in said solution obtained from the 1) step, to make the content of assistant agent in the final metal nanoparticle collosol preferably in the range of 1.5×10⁻⁴ g/mL to 2.1×10⁻³ g/mL, said assistant agent is preferably at least one of polyvinylpyrrolidone, sodium citrate, cetyl trimethyl ammonium bromide, sodium dodecyl sulfate, sodium dodecyl sulfonate, said assistant agent acts as a dispersant, which enables the solution obtained from the 1) step to form an uniform dispersion, preventing the final metal nanoparticle from agglomerating;

3) weighing reducing agent substance and dissolving in solvent, to prepare reducing agent solution, of which the concentration is in a preferred range of 1×10⁻³ mol/L to 1×10⁻² mol/L; said reducing agent is preferably at least one of hydrazine hydrate, ascorbic acid, sodium borohydride; said solvent is preferably water and/or ethanol;

4) under the condition of magnetic stirring, adding the reducing agent solution obtained from the 3) step into the solution obtained from the 2) step according to the molar ratio of reducing agent to metal ion, which is in the range of 1.2 to 4.8:1; reacting for 10 to 45 min and then obtaining metal nanoparticle collosol.

A preferred method of making said metal nanoparticle blended collosol is: the metal nanoparticle is subject to the surface treatment by adding metal nanoparticle collosol into the surface treatment agent solution, which is but not limited to polyvinylpyrrolidone (PVP); stirring and reacting to obtain metal nanoparticle blended collosol containing metal nanoparticle. Herein, the content of the addition amount of PVP in metal nanoparticle blended collosol is in a preferred range of 0.001 g/mL to 0.01 g/mL, PVP is provided for surface treatment of the metal nanoparticle, the time of the surface treatment is in a preferred range of 8 to 24 h, the objective of adding surface treatment agent is to improve the adsorption and deposition properties of metal nanoparticle, the objective of stirring and reacting is to make the surface of metal nanoparticle rough, which is beneficial to the adsorption and deposition of metal nanoparticle.

A preferred method of making said metal mixed solution is: according to the stoichiometric ratio of the corresponding elements in the chemical formula of (Y₁₋ₓCeₓ)₃(Al_{1-y}Ga_{y})₅O₁₂, mixing yttrium salt, cerium salt, aluminum salt, gallium salt under the condition of magnetic stirring, adding into metal nanoparticle blended collosol under the temperature in the range of 70 to 90° C., stirring completely to form metal nanoparticle mixed solution. Herein, yttrium salt is preferably one or two of Y (NO₃)₃, YCl₃; cerium salt is preferably one or two of Ce (NO₃)₃, CeCl₃; aluminum salt is preferably one or two of Al(NO₃)₃, AlCl₃; gallium salt is preferably one or two of Ga(NO₃)₃, GaCl₃; herein, the temperature is preferably controlled by heating in water-bath.

A preferred method of making said precursor is: measuring citric acid monohydrate, which is 1 to 3 times as much as the molar mass of total metal ion in metal mixed solution, and dissolving in alcohols to prepare alcoholic solution of citric acid monohydrate with a concentration of 1.1 to 3.3 mol/L, dripping into said metal mixed solution, then adjusting the pH of said mixed solution to 3 to 5 with weak base, keep the temperature constant in a range of 70 to 90° C. for 3 to 6 hours by stirring in water-bath, then drying to obtain precursor. Herein, citric acid monohydrate can be directly added into metal mixed solution, but considering the reaction rate in this step, citric acid monohydrate is preferably made into alcoholic solution so that citric acid monohydrate can disperse in metal mixed solution rapidly and uniformly; said alcohols is preferably but not limited to ethanol, also, other common alcohols like methanol can be used; the used weak base is preferably ammonia water, in a preferred embodiment, when adjusting the pH of mixed solution to 3 to 5 with ammonia water, it is necessary to seal the reaction system against the volatilization of ammonia water; said drying preferably comprises: pre-drying in blast drying oven under the temperature in the range of 60 to 90° C., after that, stoving under the temperature in the range of 90 to 50° C.; pre-drying can be natural drying, drying in the sun or other methods. In this step, citric acid monohydrate acts as a complexing agent; in order to avoid the introduction of other impurities, weak base is preferably ammonia water.

Said pre-burning is preferably carried out under the temperature in the range of 800 to 1200° C. for 3 to 8 h by placing precursor into high temperature furnace, the pre-burned precursor can be grinded before being calcinated in high temperature furnace or tube furnace, this helps remove organics from precursor; calcinating is preferably carried out in reducing atmosphere under the temperature in the range of 900 to 1450° C. for 2 to 5 h by placing the pre-burned precursor into box-type high-temperature furnace or tube furnace; said reducing atmosphere is preferably any gas selected from mixed gas of nitrogen and hydrogen, pure hydrogen, carbon monoxide; in a preferred embodiment, when the reducing atmosphere is mixed gas of nitrogen and hydrogen, the volume ratio of nitrogen to hydrogen is preferably 95:5 or 90:10.

The rare earth-aluminium/gallate based fluorescent material is prepared by using wet chemical method, that not only lower the temperature in the synthesis reaction, but also to improve the microstructure and macroscopic properties of the rare earth-aluminium/gallate based fluorescent material, the obtained rare earth-aluminium/gallate based fluorescent material have uniform particle size distribution, the luminescent performances of the material are improved effectively. Also, the particle size of the rare earth-aluminium/gallate based fluorescent material can be flexibly adjusted by controlling the metal nanoparticle diameter and the thickness of (Y₁₋ₓCeₓ)₃(Al_{1-y}Ga_{y})₅O₁₂ without the introduction of other impurities to obtain products of high quality. Meanwhile, the only requirement of the manufacturing method of the rare earth-aluminium/gallate based fluorescent material is to control temperature and add reactants in an appropriate proportion, the products can be obtained. Thus, the preparation process is simple, low equipment requirements, no pollution, easy to control, suitable for industrial production.

Special examples are disclosed as follows to demonstrate manufacturing method of rare earth-aluminium/gallate based fluorescent material and the performance of it.

### EXAMPLE 1

The manufacturing of a rare earth-aluminium/gallate based fluorescent material having chemical formula of (Y_{0.5}Ce_{0.5})₃(Al_{0.5}Ga_{0.5})₅O₁₂@ Au by using sol-gel coating method:

The manufacturing method of Au nanoparticle is: weighing and dissolving 20.6 mg of chloroauric acid (AuCl₃.HCl.4H₂O) in 16.8 mL of deionized water, after chloroauric acid dissolved completely, aqueous solution of chloroauric acid is obtained; weighing and dissolving 14 mg of sodium citrate and 6mg of cetyl trimethyl ammonium bromide in the aqueous solution of chloroauric acid under the condition of magnetic stirring, solution A is obtained; weighing and dissolving 1.9 mg of sodium borohydride and 17.6 mg of ascorbic acid in 10mL of deionized water, respectively, obtaining 10 mL of 5×10⁻³ mol/L aqueous solution of sodium borohydride and 10 mL of 1×10⁻² mol/L aqueous solution of ascorbic acid; under the condition of magnetic stirring, adding 0.08 mL aqueous solution of sodium borohydride into the solution A, stirring and reacting for 5 min, and then adding 3.12 mL of 1×10⁻² mol/L aqueous solution of ascorbic acid into the solution A, continue to react for 30 min, then obtaining 20 mL of Au nanoparticle collosol containing 5×10⁻³ mol/L of Au; taking and placing 8 mL of 533 10⁻³ mol/L Au nanoparticle collosol into a beaker, and adding 10 mg of PVP, magnetically stirring for 8 h. The surface-treated Au nanoparticle blended collosol B is obtained.

The manufacturing method of (Y_{0.5}Ce_{0.5})₃(Al_{0.5}Ga_{0.5})₅O₁₂@ Au is: placing 10 mL of 1.0 mol/L Al(NO₃)₃ solution, 6.0 ml of 1 mol/L Y(NO₃)₃ solution, 10 ml of lmol/L Ga(NO₃)₃ solution and 6.0 ml of 1 mol/L Ce(NO₃)₃ solution into a conical flask, under the condition of magnetic stirring, heating in water-bath which is maintained at 70° C., then adding said Au nanoparticle blended collosol B, stirring uniformly to get metal mixed solution C; weighing 6.7245 g of citric acid monohydrate (the amount is as much as the molar mass of total metal ion in metal mixed solution C) and dissolving in 30 ml of ethanol to make up solution, dripping the solution into the metal mixed solution C, then adding ammonia water to adjust pH to about 3, placing into 90° C. water-bath, stirring, and keep the temperature constant for 3 h, drying in blast drying oven at 60° C. for 12 h, then drying completely at 150° C. to obtain precursor; placing the precursor into high temperature furnace and pre-burning at 800° C. for 8 h, cooling to the room temperature, grinding, then placing into tube furnace, calcinating in reducing atmosphere (the volume ratio of N₂ to H₂ is 90:10) at 1200° C. for 3 h, naturally cooling. The desired fluorescent material (Y_{0.5}Ce_{0.5})₃(Al_{0.5}Ga_{0.5})₅O₁₂@ Au is obtained.

### EXAMPLE 2

The manufacturing of a rare earth-aluminium/gallate based fluorescent material having chemical formula of (Y_{0.98}Ce_{0.02})₃Al₅O₁₂@ Ag by using sol-gel coating method:

The manufacturing method of Ag nanoparticle is: weighing and dissolving 3.40 mg of silver nitrate (AgNO₃) in 18.4 mL of deionized water, after silver nitrate dissolved completely, aqueous solution of silver nitrate is obtained; weighing and dissolving 42 mg of sodium citrate in the aqueous solution of silver nitrate under the condition of magnetic stirring, solution A is obtained; weighing and dissolving 5.7 mg of sodium borohydride in 10 mL of deionized water obtaining 10 ml of 1.5×10⁻² mol/L aqueous solution of sodium borohydride; under the condition of magnetic stirring, adding 1.6 mL of 1.5×10⁻² mo1/L aqueous solution of sodium borohydride into the solution A at once, continue to react for 10 min, then obtaining 20 mL of Ag nanoparticle collosol containing 1×10⁻³ mol/L of Ag; taking 2 mL of 1×10⁻³ mol/L Ag nanoparticle collosol into a beaker, and adding 2 mg of PVP, magnetically stirring for 12 h. The surface-treated Ag nanoparticle blended collosol B is obtained.

The manufacturing method of (Y_{0.98}Ce_{0.02})₃Al₅O_{12@} Ag is: placing 20 mL of 1.0 mol/L Al(NO₃)₃ solution, 11.8 ml of 1 mol/L Y(NO₃)₃ solution, 1.2 ml of 0.2 mol/L Ce(NO₃)₃ solution into a conical flask, under the condition of magnetic stirring, heating in water-bath which is maintained at 80° C., then adding said Ag nanoparticle blended collosol B, stirring uniformly to get metal mixed solution C; weighing 13.4490 g of citric acid monohydrate (the amount is 2 times as much as the molar mass of total metal ion in metal mixed solution C) and dissolving in 30 ml of ethanol to make up solution, dripping the solution into the metal mixed solution C, then adding ammonia water to adjust pH to about 4, placing into 80° C. water-bath, stirring, and keep the temperature constant for 6 h, drying in blast drying oven at 60° C. for 10 h, then drying completely at 100° C. to obtain precursor; placing the precursor into high temperature furnace and pre-burning at 1200° C. for 6 h, cooling to the room temperature, grinding, then placing into tube furnace, calcinating in reducing atmosphere (the volume ratio of N₂ to H₂ is 95:5) at 1300° C. for 3 h, naturally cooling. The desired fluorescent material (Y_{0.98}Ce_{0.02})₃Al₅O₁₂@ Ag is obtained. The no metal nanoparticle-coating fluorescent material (Y_{0.98}Ce_{0.02})₃Al₅O₁₂ is prepared using the same method.

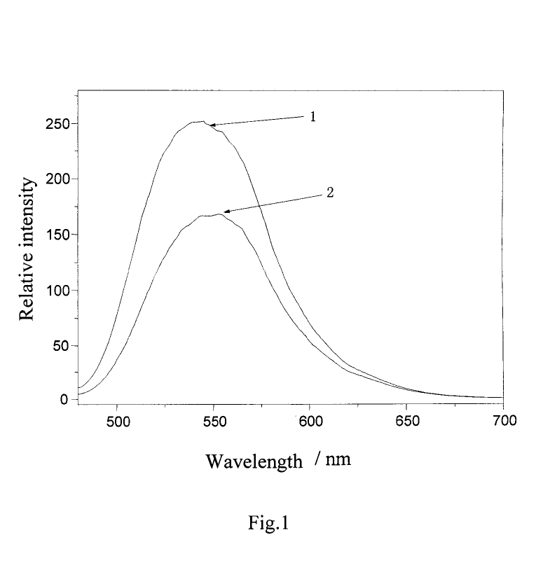

FIG. 1 is an emission spectrum of rare earth-aluminium/gallate based fluorescent material in Example 2 of the present invention with respect to (Y_{0.98}Ce_{0.02})₃Al₅O₁₂ at an excitation wavelength of 473 nm. Herein, curve 1 is the emission spectrum of the fluorescent material (Y_{0.98}Ce_{0.02})₃Al₅O₁₂@Ag; curve 2 is the emission spectrum of the fluorescent material (Y_{0.98}Ce_{0.02})₃Al₅O₁₂. The luminous intensity of metal nanoparticle-coating material is 40% higher than that of no metal nanoparticle-coating material.

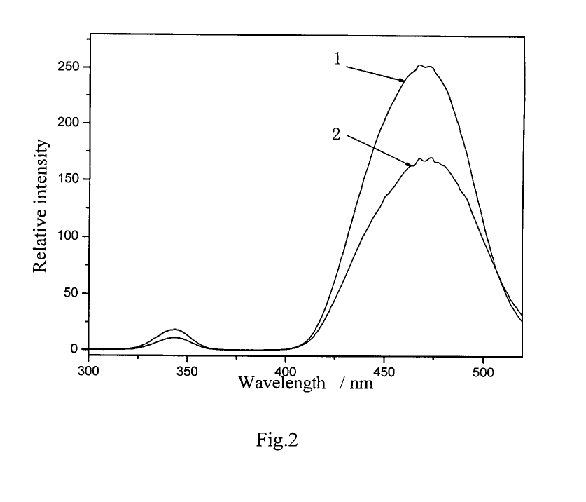

FIG. 2 is an excitation spectrum of the fluorescent material in Example 2 of the present invention with respect to (Y_{0.98}Ce_{0.02})₃Al₅O₁₂. Herein, curve 1 is the excitation spectrum of the fluorescent material (Y_{0.98}Ce_{0.02})₃Al₅O₁₂@Ag at a monitoring wavelength of 542 nm; curve 2 is the excitation spectrum of the fluorescent material (Y_{0.98}Ce_{0.02})₃Al₅O₁₂ at a monitoring wavelength of 552 nm.

### EXAMPLE 3

The manufacturing of a rare earth-aluminium/gallate based fluorescent material having chemical formula of (Y_{0.95}Ce_{0.05})₃Ga₅O₁₂@ Pt by using sol-gel coating method:

The manufacturing method of Pt nanoparticle is: weighing and dissolving 5.18 mg of chloroplatinic acid (H₂PtCl₆.6H₂O) in 17 mL of deionized water, after chloroplatinic acid dissolved completely, aqueous solution of chloroplatinic acid is obtained; weighing and dissolving 8mg of sodium citrate and 12 mg of sodium dodecyl sulfonate in the aqueous solution of chloroplatinic acid under the condition of magnetic stirring, solution A is obtained; weighing and dissolving 0.38 mg of sodium borohydride in 10 mL of deionized water obtaining 10 mL of 1×10⁻³ mol/L aqueous solution of sodium borohydride, preparing 10 mL of 1×10⁻² mol/L hydrazine hydrate solution at the same time; under the condition of magnetic stirring, adding 0.4 mL aqueous solution of sodium borohydride into the solution A, stirring and reacting for 5 min, and then adding 2.6 mL of 1×10⁻² mol/L hydrazine hydrate solution into the solution A, continue to react for 40 min, then obtaining 20 mL of Pt nanoparticle collosol containing 5×10⁻⁴ mo1/L of Pt; taking 16 mL of 5×10⁻⁴ mol/L Pt nanoparticle collosol into a beaker, and adding 16 mg of PVP, magnetically stirring for 12 h. The surface-treated Pt nanoparticle blended collosol B is obtained.

The manufacturing method of (Y_{0.95}Ce_{0.05})₃Ga₅O₁₂@ Pt is: placing 20 mL of 1.0 mol/L Ga(NO₃)₃ solution, 11.4 ml of 1.0 mol/L Y(NO₃)₃ solution, 0.6 ml of 1 mol/L Ce(NO₃)₃ solution into a conical flask, under the condition of magnetic stirring, heating in water-bath which is maintained at 90° C., then adding said Pt nanoparticle blended collosol B, stirring uniformly to get metal mixed solution C; weighing 13.4490 g of citric acid monohydrate (the amount is 2 times as much as the molar mass of total metal ion in metal mixed solution C) and dissolving in 30 ml of ethanol to make up solution, dripping the solution into the metal mixed solution C, then adding ammonia water to adjust pH to about 5, placing into 90° C. water-bath, stirring, and keep the temperature constant for 3 h, drying in blast drying oven at 90° C. for 15 h, then drying completely at 120° C. to obtain precursor; placing the precursor into high temperature furnace and pre-burning at 1000° C. for 3 h, cooling to the room temperature, grinding, then placing into tube furnace, calcinating in reducing atmosphere (the volume ratio of N₂ to H₂ is 90:10) at 1450° C. for 2 h, naturally cooling. The desired fluorescent material (Y_{0.95}Ce_{0.05})_{3Ga}₅O₁₂@ Pt is obtained.

### EXAMPLE 4

The manufacturing of a rare earth-aluminium/gallate based fluorescent material having chemical formula of (Y_{0.75}Ce_{0.25})₃(Al_{0.8}Ga_{0.2})₅O₁₂@ Pd by using sol-gel coating method:

The manufacturing method of Pd nanoparticle is: weighing and dissolving 0.43 mg of palladium chloride (PdCl₂.2H₂O) in 8.5 mL of deionized water, after palladium chloride dissolved completely, aqueous solution of palladium chloride is obtained, weighing and dissolving 11 mg of sodium citrate and 4 mg of sodium dodecyl sulfate in the aqueous solution of palladium chloride under the condition of magnetic stirring, solution A is obtained; weighing and dissolving 3.8 mg of sodium borohydride in 10 mL of deionized water obtaining 1×10⁻² mol/L reducing aqueous solution of sodium borohydride; under the condition of magnetic stirring, adding rapidly 0.48 mL of 1×10⁻² mol/L aqueous solution of sodium borohydride into the solution A, continue to react for 20 min, then obtaining 10 mL of Pd nanoparticle collosol containing 1×10⁻⁴ mol/L of Pd; taking 4 mL of 1×10⁻⁴ mol/L Pd nanoparticle collosol into a beaker, and adding 5 mg of PVP, magnetically stirring for 8 h. The surface-treated Pd nanoparticle blended collosol B is obtained.

The manufacturing method of (Y_{0.75}Ce_{0.25})₃(Al_{0.8}Ga_{0.2})₅O₁₂@ Pd is: placing 16 mL of 1.0 mol/L Al(NO₃)₃ solution, 4.0 ml of 1 mol/L Ga(NO₃)₃ solution, 9.0 ml of 1 mol/L Y(NO₃)₃ and 3.0 ml of 1 mol/L Ce(NO₃)₃ solution into a conical flask, under the condition of magnetic stirring, heating in water-bath which is maintained at 80° C., then adding said Pd nanoparticle blended collosol B, stirring uniformly to get metal mixed solution C; weighing 20.1734 g of citric acid monohydrate (the amount is 3 times as much as the molar mass of total metal ion in metal mixed solution C) and dissolving in 30 ml of ethanol to make up solution, dripping the solution into the metal mixed solution C, then adding ammonia water to adjust pH to about 5, sealing, placing into 80° C. water-bath, stirring, and keep the temperature constant for 5 h, drying in blast drying oven at 60° C. for 12 h, then drying completely at 100° C. to obtain precursor; placing the precursor into high temperature furnace and pre-burning at 1200° C. for 5 h, cooling to the room temperature, grinding, then placing into tube furnace, calcinating in reducing atmosphere (CO) at 900° C. for 5 h, naturally cooling. The desired fluorescent material (Y_{0.7}Ce_{0.3})₃(Al_{0.8}Ga_{0.2})₅O₁₂@Pd is obtained.

### EXAMPLE 5

The manufacturing of a rare earth-aluminium/gallate based fluorescent material having chemical formula of (Y_{0.9}Ce_{0.1})₃(Al_{0.2}Ga_{0.8})₅O₁₂@ Ag by using sol-gel coating method:

The manufacturing method of Ag nanoparticle is: weighing and dissolving 3.40 mg of silver nitrate (AgNO₃) in 18.4 mL of deionized water, after silver nitrate dissolved completely, aqueous solution of silver nitrate is obtained; weighing and dissolving 42 mg of sodium citrate in the aqueous solution of silver nitrate under the condition of magnetic stirring, solution A is obtained; weighing and dissolving 5.7 mg of sodium borohydride in 10 mL of deionized water obtaining 10 ml of 1.5×10⁻² mol/L aqueous solution of sodium borohydride; under the condition of magnetic stirring, adding 1.6 mL of 1.5×10⁻² mol/L aqueous solution of sodium borohydride into solution A at once, continue to react for 10 min, then obtaining 20 mL of Ag nanoparticle collosol containing 1×10⁻³ mol/L of Ag; taking 4 mL of 1×10⁻³ mol/L Ag nanoparticle collosol into a beaker, and adding 40 mg of PVP, magnetically stirring for 24 h. The surface-treated Ag nanoparticle blended collosol B is obtained.

The manufacturing method of (Y_{0.9}Ce_{0.1})₃(Al_{0.2}Ga_{0.8})₅O₁₂ is: placing 10.8 mL of 1.0 mol/L Y(NO₃)₃ solution, 2.4 ml of 1 mol/L Ce(NO₃)₃ solution, 4.0 ml of 1 mol/L Al(NO₃)₃ solution and 16 ml of 1 mol/L Ga(NO₃)₃ solution into a conical flask, under the condition of magnetic stirring, heating in water-bath which is maintained at 80° C., then adding said Ag nanoparticle blended collosol B, stirring uniformly to get metal mixed solution C; weighing 13.4490 g of citric acid monohydrate (the amount is 2 times as much as the molar mass of total metal ion in metal mixed solution C) and dissolving in 30 ml of ethanol to make up solution, dripping the solution into the metal mixed solution C, then adding 1 mol/L sodium bicarbonate solution to adjust pH to about 4, placing into 80° C. water-bath, stirring, and keep the temperature constant for 6 h, drying naturally, then drying completely at 100° C. to obtain precursor; placing the precursor into tube furnace and calcinating in reducing atmosphere (H₂) at 1200° C. for 4 h, cooling to the room temperature. The desired fluorescent material (Y_{0.9}Ce_{0.1})₃(Al_{0.2}Ga_{0.8})₅O₁₂@ Ag is obtained.

### EXAMPLE 6

The manufacturing of a rare earth-aluminium/gallate based fluorescent material having chemical formula of (Y_{0.9}Ce_{0.1})₃(Al_{0.2}Ga_{0.8})₅O₁₂@ Pt/Au by using sol-gel coating method:

The manufacturing method of Pt/Au nanoparticle is: weighing and dissolving 6.2 mg of chloroauric acid (AuCl₃.HCl.4H₂O) and 7.8 mg of chloroplatinic acid (H₂PtCl₆.6H₂O) in 28 mL of deionized water, mixed solution of chloroauric acid and chloroplatinic acid is obtained; after dissolved completely, weighing and dissolving 22 mg of sodium citrate and 20 mg of PVP in the mixed solution under the condition of magnetic stirring, solution A is obtained; weighing and dissolving 5.7 mg of sodium borohydride 10 mL of deionized water, obtaining 10 mL of 1.5×10⁻² mol/L aqueous solution of sodium borohydride; under the condition of magnetic stirring, adding 2 mL of 1.5×10⁻² mol/L aqueous solution of sodium borohydride into the solution A at once, continue to react for 20 min, then obtaining 30 mL of Pt/Au nanoparticle collosol containing 1×10⁻³ mol/L of total metal particle; taking 5 mL of Pt/Au nanoparticle collosol and adding 20 mg of PVP, magnetically stirring for 6 h. The surface-treated Pt/Au nanoparticle blended collosol B is obtained.

The manufacturing method of (Y_{0.9}Ce_{0.1})₃(Al_{0.2}Ga_{0.8})₅O₁₂@ Pt/Au is: placing 10.8 mL of 1.0 mol/L YCl₃ solution, 2.4 ml of 1 mol/L CeCl₃ solution, 4.0 ml of 1 mol/L AlCl₃ solution and 16 ml of 1 mol/L GaCl₃ solution into a conical flask, under the condition of magnetic stirring, heating in water-bath which is maintained at 70° C., then adding the Pt/Au nanoparticle blended collosol B, stirring uniformly to get metal mixed solution C; weighing 13.4490 g of citric acid monohydrate (the amount is 2 times as much as the molar mass of total metal ion in metal mixed solution C) and dissolving in 30 ml of ethanol to make up solution, dripping the solution into the metal mixed solution C, then adding ammonia water to adjust pH to about 4, placing into 70° C. water-bath, stirring, and keep the temperature constant for 6 h, drying in blast drying oven at 60° C. for 12 h, then drying completely at 90° C. to obtain precursor; placing the precursor into high temperature furnace and pre-burning at 1200° C. for 4 h, cooling to the room temperature, grinding, then placing into tube furnace, calcinating in reducing atmosphere (H₂) at 1300° C. for 3 h, naturally cooling. The desired fluorescent material (Y_{0.9}Ce_{0.1})₃(Al_{0.2}Ga_{0.8})₅O₁₂@ Pt/Au is obtained.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

1. A rare earth-aluminium/gallate based fluorescent material comprising a core, and a shell which coats said core, wherein said core is a metal nanoparticle, and said shell is a fluorescent powder having chemical formula of (Y₁₋ₓCeₓ)₃(Al_{1-y}Ga_{y})₅O₁₂, wherein 0<x≦0.5, 0≦y≦1.0.

2. The rare earth-aluminium/gallate based fluorescent material as in claim 1, wherein the molar ratio of said core to shell is larger than 0, less than 1×10⁻²; wherein 0.02≦x≦0.25, 0.2≦y≦0.8 or/and 1×10⁻⁴≦y≦1×10⁻³.

3. The rare earth-aluminium/gallate based fluorescent material as in claim 1, wherein said metal nanoparticle is at least one of Ag, Au, Pt, Pd.

4. The rare earth-aluminium/gallate based fluorescent material as in claim 1, wherein said shell coats said core in layered form, said rare earth-aluminium/gallate based fluorescent material has spherical or spherical-like particulate structure.

5. A manufacturing method of rare earth-aluminium/gallate based fluorescent material, comprising:
dissolving corresponding metal compound of metal nanoparticle, and then mixing with assistant agent and reducing agent successively, to obtain metal nanoparticle collosol; adding the metal nanoparticle collosol into polyvinylpyrrolidone, mixing and stirring to obtain metal nanoparticle blended collosol;
according to the stoichiometric ratio of the corresponding elements in the chemical formula of (Y₁₋ₓCeₓ)₃(Al_{1-y}Ga_{y})₅O₁₂, mixing yttrium salt, cerium salt, aluminum salt, gallium salt, then adding into said metal nanoparticle blended collosol under the temperature in the range of 70 to 90° C., obtaining metal mixed solution, wherein <x≦0.5, 0≦y≦1.0;
adding citric acid monohydrate into said metal mixed solution, then adjusting pH of mixed solution to 3 to 5 with weak base, keep the temperature constant in a range of 70 to 90° C. for 3 to 6 hours, then drying to obtain precursor;
pre-burning said precursor, then calcinating in reducing atmosphere, cooling and then grinding, obtaining said rare earth-aluminium/gallate based fluorescent material.

6. The manufacturing method of rare earth-aluminium/gallate based fluorescent material as in claim 5, wherein, in the step of making said metal nanoparticle collosol, the corresponding metal compound of metal nanoparticle is at least one of silver nitrate, chloroauric acid, chloroplatinic acid, palladium chloride;
said assistant agent is at least one of polyvinylpyrrolidone, sodium citrate, cetyl trimethyl ammonium bromide, sodium dodecyl sulfate, sodium dodecyl sulfonate;
said reducing agent is at least one of hydrazine hydrate, ascorbic acid, sodium borohydride.

7. The manufacturing method of rare earth-aluminium/gallate based fluorescent material as in claim 5, wherein the molar ratio of said corresponding metal ion of metal nanoparticle to reducing agent is 1:1.2 to 4.8.

8. The manufacturing method of rare earth-aluminium/gallate based fluorescent material as in claim 5, wherein, in the step of making said metal mixed solution, said yttrium salt is at least one of Y (NO₃)₃, YCl₃;
said cerium salt is at least one of Ce (NO₃)₃, CeCl₃;
said aluminum salt is at least one of Al (NO₃)₃, AlCl₃;
said gallium salt is at least one of Ga (NO₃)₃, GaCl₃.

9. The manufacturing method of rare earth-aluminium/gallate based fluorescent material as in claim 5, wherein, in the step of making said precursor, citric acid monohydrate is made into alcoholic solution of citric acid monohydrate before being used, the molar ratio of citric acid monohydrate to total metal ion in metal mixed solution is 1 to 3:1;
said weak base is ammonia water;
said drying comprises: pre-drying under the temperature in the range of 60 to 90° C., then stoving under the temperature in the range of 90 to 150° C.

10. The manufacturing method of rare earth-aluminium/gallate based fluorescent material as in claim 5, wherein,
said pre-burning is carried out under the temperature in the range of 800 to 1200° C. for 3 to 8 hours;
said calcination is carried out under the temperature in the range of 900 to 1450° C. for 2 to 5 hours;
said reducing atmosphere is any gas selected from mixed gas of nitrogen and hydrogen, pure hydrogen, carbon monoxide.

11. The manufacturing method of rare earth-aluminium/gallate based fluorescent material as in claim 6, wherein the molar ratio of said corresponding metal ion of metal nanoparticle to reducing agent is 1:1.2 to 4.8.
